(19) United States
(12) Patent Application Publication
(10) Pub. No.: US 2015/0276232 A1
(43) Pub. Date: Oct. 1, 2015

(54) Bovine or equine water jacket and combined heat and power cogeneration system

(71) Applicant: YANMING WEI, Mountain (CA)

(72) Inventor: YANMING WEI, Mountain (CA)

(21) Appl. No.: 14/242,030

(22) Filed: Apr. 1, 2014

(51) Int. Cl. F24D 3/14; A01K 13/00

(52) U.S. Cl. CPC F24D 3/14; A01K 13/006; F24D 2200/28

(57) ABSTRACT

Large size livestock animal, such as cow and horse, emits significant heat energy all time. A special device of water jacket works both as animal clothes and thermal collector. There are 3 hoses attached to the water jacket: 2 for water circulation; 1 for skin vapor collection. Animals are penned on an open camp or uninsulated tie-stall barn. All hoses are hooked to a pipe matrix that is systematically connected to a barn-side water tank and vapor compressor. Another building-side water tank is used to store higher temperature water that is the direct heat source of a radiant floor heating system. The heat pump draws heat from barn-side warm water tank, and discharges heat to building-side water tank, then supports radiant floor heating system in winter or heat engine power plant in summer. Water jack can also relieve the animal heat stress, because underground water is cooler than ambient air during hot season.

### BACKGROUND

Living animal is a source of heat. The heat is more significant for large size animal.

Studies show that the adult bovine or equine animal such as cow, cattle, horse, is equivalent to a heater of 1 kw to 1.5 kw, average 1.2 kw power in the sense of thermology. The body temperature is commonly around 38 Celsius degree. Researches recognize that thereof 1.2 kw heat is mostly dissipated by radiant and convection (about 70%), the other 30% by water vapor. The insensible vapor loss via skin pores is about equivalent to 6.2 liters water per day. The urine water loss is about 15 liters per day. Because the enthalpy of vapor is far bigger than water, so the less vapor still carries more heat than the large volume urine. The manure alone constitutes another significant bio-chemical energy that can be extracted by anaerobic digester.

Utilizing such a special heat source is the main purpose of the present invention. However, livestock is farmer's livelihood, so the animal health should also be in same importance as its thermal energy utilization. And the humanity concern of animal protection activists have also be respected in present invention.

All animals consume oxygen and emit carbon dioxide, water, and vapor. When a herd high densely live in a barn, the ventilation should be the first consideration in the highest priority; then keeping the animal warm is the next consideration. Making the animal comfortable requires both good ventilation and good insulation, though ventilation is often conflicting with insulation, especially in winter season.

Generally speaking, barn size is often in a plurality of times than the regular size of resident house. Vast space makes expensive heat exchanger low efficiency.

In recent years, the radiant floor heating technology is well developed and widely applied in both industrial and resident house heating. There is a small difference between livestock body temperature and inlet temperature of radiant floor heating system. Luckily the modern heat pump technology can efficiently work across such a small temperature difference.

Nowadays Combined Heat and Power system (CHP) is in trend. For large scale dairy farm, heat power of cow is possible to be harnessed for forming a commercial CHP plant. For example, a regular midsize diary farm of 500 cows, the potential body-heat-only energy is about 500 kw. A regular 30% thermal efficiency engine can convert the 500 kw heat to 150 kw mechanical work or electric power. The lagoons in most dairy operations have not been used for power generation. An onsite CHP can make use of lagoon bed as one of 2 heat reservoirs of heat engine.

### PRIOR ART

US patent 20110283952 “conductive cooling method and system for livestock farm operations” and U.S. Pat. No. 4,322,953 “Heat collection system”, both of them simply employ heat exchanger hanging over ventilation channel way. Most heat is lost during ventilation.

Some other bellowing patents are also relevant to present invention in a weak association:

U.S. Pat. No. 4,747,537: “Energy saving system for controlling the temperature of buildings used for raising large numbers of animals”.

U.S. Pat. No. 4,706,883: Pump heating system.

U.S. Pat. No. 4,263,785: Method and system for recovering heat in association with dairy operations.

U.S. Pat. No. 4,444,020: Heat transformation process and apparatus for air-conditioning in rooms for a great number of living creatures, particularly building for animal breeding.

### SUMMARY OF THE INVENTION

One of the key improvements to prior art is to let livestock animals wear special water jackets. The animal clothes effectively resolve the confliction of ventilation and insulation. A lower cost frame only tie-stall barn can serve the present invention. Even open air peg-tied herd camp may work.

There are 3 hoses with the water jacket. 2 hoses are for water inlet and outlet, 1 hose is for vapor collection. The outside of the jacket should be insulated; the jacket surface that contacts animal skin features some a plurality of uniform mild prods or studs that can make small gap for vapor flowing and itch quenching. All water hoses are hooked to floor pipe matrix that circulates water between distributed water jackets and barn-side insulated tank. All vapor hoses are hooked to vapor compressor inlet port.

The temperature of water jack is recommended to be controlled about 25 Celsius degree by valve and/or water pump. The temperature difference between the water jacket and animal body is about 13 Celsius degree that is good trade-off for animal comfort and thermal transfer.

The vapor collected from animal body is compressed to high pressure and high temperature; the huge latent heat is then dissipated through condenser that is submerged in barn-side water tank. The condensed water is discharged to same tank.

Another tank nearby house is set for both Radiant Floor Heating System (RFHS) and heat engine power generator. Sometimes it is referred as house-side tank.

RFHS usually features a plurality of non-metal pipe loops that are uniformly buried underneath concrete. The inlet temperature is about 65 Celsius degree, and outlet temperature is about 40 Celsius degree. The water circulation makes the space temperature controlled at about 20 Celsius degree.

House-side tank also serves as heat engine hot heat reservoir, as well as cold heat reservoir can be selected between ambient air and onsite geo-type resource such as pond or dairy lagoon bed where temperature is about 4 Celsius degree. In winter, ambient air temperature may be as low as −40 Celsius degree that is better choice for cold heat reservoir than geo-type resource; in non-winter, geo-type resource may be better than ambient atmosphere. Therefore a 3-way valve control is used for the cold heat reservoir switching purpose to optimize heat engine work condition.

The temperature difference between cold heat reservoir and hot heat reservoir matters both for heat pump and heat engine; the more, the better efficiency for heat engine, as well as, the small, the better Co-efficient Of Performance (COP) for heat pump. Therefore, in the present invention, the temperature difference of heat engine—about 61 (summer) to 100 (winter) Celsius degree, is always bigger than that of heat pump—about 40 Celsius degree.

If the heated space temperature is only expected to be above frozen point to 10 Celsius degree in winter for economic or special purpose use, or to be an air conditioner in summer, then water in the barn-side warm tank can be simply pumped to the inlet of the RFHS. As regular RFHS usually employs buried pipe loops, but if inlet temperature is far below than 65 Celsius degree, pipe loops is hard to maintain space temperature, alternatively, a coverall large capacity water carpet will work better. In this simplest application that the warm water from water jackets directly heats or air-conditions house without heat pump, the barn-side water tank is optional, instead the house water carpet can play the role of water tank.

For the application of workshop or house that 20 Celsius degree inside is a must, a heat pump should be deployed to transfer heat from barn-side warm tank to house-side hot tank.

As the winter cold ambient air is ideal cold reservoir for heat engine, even with the RFHS heating, the house-side hot water tank can still simultaneously used as hot reservoir for heat engine to generate electric power.

In seasons other than winter, especially in summer, the ambient temperature may be very close to or even higher than livestock core temperature. The heat stress is a risk to livestock health. The 25 Celsius degree water jackets make the animals feel cool and comfortable.

Compared to temperature in house-side hot water tank, non-winter ambient temperature may be not low enough as a cold reservoir, as well as RFHS may be shutdown because of no need of heating. The heat exchanger buried under onsite lagoon bed will communicate with alternative geothermal cold reservoir. Then the house-side hot water tank now only serves the heat engine to generate electric power.

While no need of heating, the RFHS is not simply shutdown, but the present invention changes its role to air conditioner when necessary. This is implemented by a 3-way valve control. The inlet of RFHS can be switched between barn-side tank and house-side tank. When RFHS plays heater role, house-side tank is hooked; otherwise barn-side tank is hooked for role of air conditioner because cool water can absorb heat from house space, as well as house-side tank is only used for power generation.

The word ‘house’ in present invention not only means resident house, but also vegetable greenhouse or other facility building. For farm business, a vegetable greenhouse is recommended to build for maximizing the advantage of the present invention.

The distance between barn and house is probably not short. The amount of working fluid that is used inside heat pump partly depends on the distance of the 2 thermal reservoirs. The longer between barn and house, the more working fluid will be invested. It is recommended to set a “shadow tank” nearby house-side tank. The “shadow tank” is connected with barn-side tank by insulated pipe in same ground level.

The water circulation between animal jacket and water tank can be aided with small electric pump. If the barn-side water tank lays on a higher platform above animal standing height, the density difference between warm water and cold water can drive circulation with the aid of gravity.

The heat pump COP can be calculated roughly as:

COP=Tc/(Th−Tc)=(273+25)/((273+65)−(273+25))=7.4

The calculation result shows that 1 watt input electric or mechanic power can “pump” 7 watts heat energy from cold heat reservoir to hot heat reservoir. In the other aspect, a regular 30% efficiency heat engine can consume 3 watts heat to produce 1 watt mechanic energy. So theoretically after the 7 watts heat energy arrives at the house-side hot tank, 3 watts heat will be deducted away for “repaying” the 1 watt heat-pumping energy, the balance 7−3=4 watts will be used for heating house by RFHS.

### BRIEF DESCRIPTION OF THE DRAWINGS AND PREFERRED EMBODIMENTS

The illustrative embodiments described in the description, drawings, and claims are not meant to be limiting. The features of the embodiments and figures described and shown herein can be used and combined with other features of other embodiments as well as figures. Some features may bear less importance, and therefore optional. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

FIG. 1 is the schematic water jacket.

FIG. 1(a) is the schematic of skin contact side, and FIG. (b) is of insulation side. The dots on skin contact surface of FIG. 1 (a) stand for the studs. It supports minimal gap between jacket and animal corpse for vapor flowing and itch scratching.

FIG. 1 (c) is the view of the CC′ cross section in FIG. 1(b). It looks like a sandwich structure. The core (3) is the inner flat rubber tube that is filled with water. The outer layer (1) is insulation sheet, and the inner layer (2) is liner sheet with studs (4). Outer layer and inner layer can be thread- sewed or welded together.

The outer side of the jacket should be well insulated to prevent heat loss.

Cotton or other similar performance material can be padded as means of insulation.

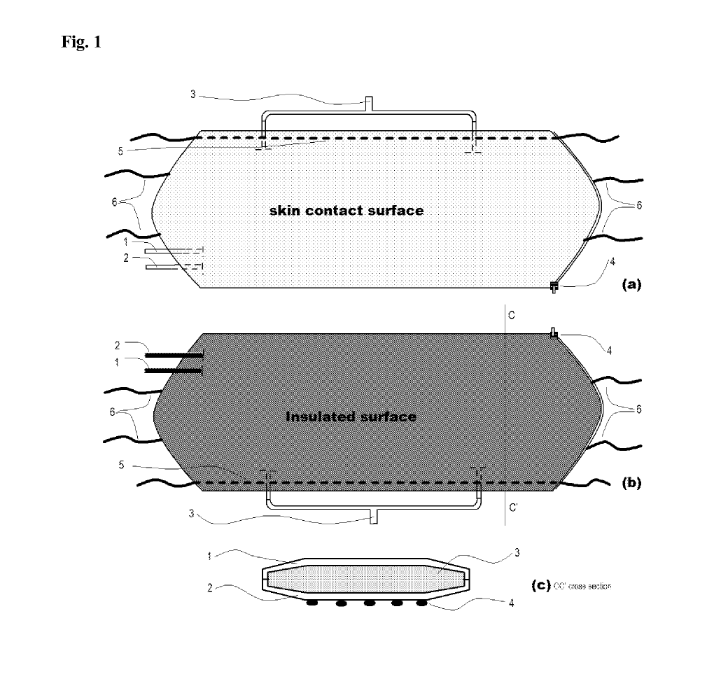

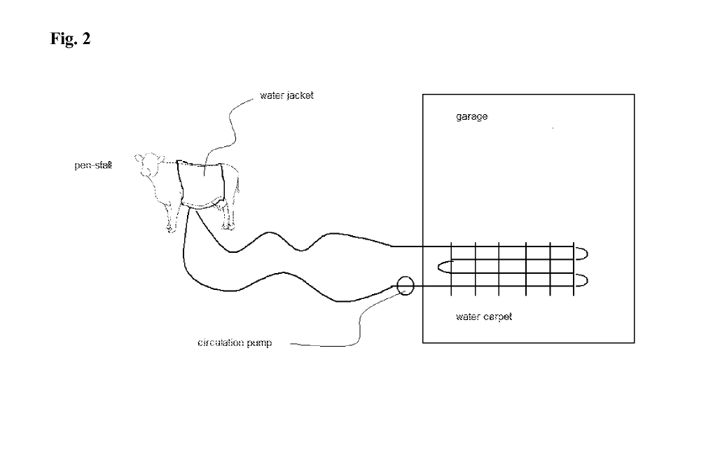

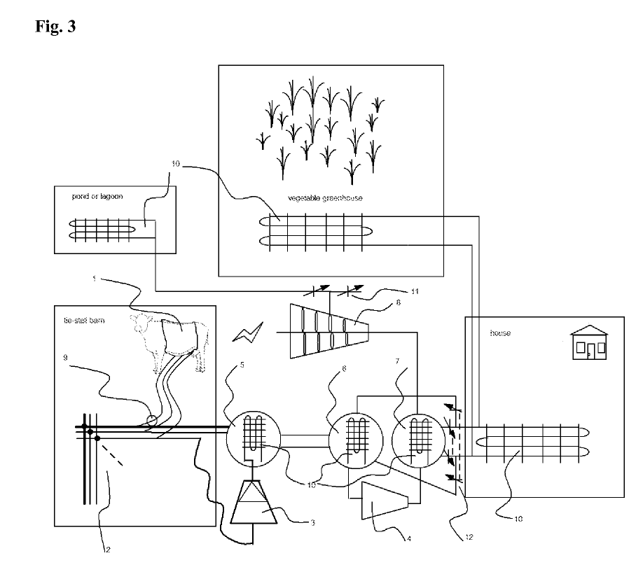

The ports (1) (2) stand for water inlet and outlet. The port (3) stands for vapor manifold outlet. The zipper (4) is used to enclose the animal body. Girdle string (5) is tucked through the vapor fitting side folding, and is used to tighten the vapor fitting side. Girdle strings (6) are used to assist zipper or buttons for tightening whole jacket on animal body surface. It is better to use flexible manifold vapor port assembly for uniformly draw vapor all around the covered animal surface. The FIG. 1 only shows 2 branches manifold, but it can have any plurality of branches.

For sealing purpose, all inlet outlet and manifold fittings should be not on inner side of jacket, but on outer side, i.e. the insulated side. Then only for the vapor extraction fittings need a vapor pass way from inner side to outer side. The grommet holes on jacket marginal area are good as a pass way. An inner flat rubber tube inside the sandwich structure water jacket is good for holding water.

The water jacket is most likely put on the bovine or equine middle belly trunk. So the zipper side is better curved with the belly shape of cow or horse. For female cow, the udder is a significant heat source, so the jacket zipper side may not be curved as regular one for more skin coverage. The full coverage on animal's all exposure skin is not practical. The belly trunk wrap jacket can cover at least 50%, most likely 80% of all skin area. This factor should be taken into consideration while calculating the heat energy usage ratio.

As large animals may exert big brutal force on wearing device, so heavy duty performance and flexibility should be considered when choosing jacket material, auxiliary parts such as zipper or button. Waterproof performance should also be considered.

Not all animals are same size, even in same herd. The massive production of water jackets is recommended to consider at least 3 difference sizes: small, large, extra large.

As the proportion of vapor latent heat is quite less than main stream radiant body heat, the vapor collection manifold can not be a must. The studs are also not a must if vapor manifold is not configured because its main function is for creating gap between animal skin and jacket, though the vapor gap may be beneficial to animal health. The system cost will be lower without the involvement of vapor heat extraction.

The arrangement and definition of the ports on jacket does not matter. Threaded or barbed ends of ports also doest not matter provided hoses can be fitted easily.

FIG. 2 illustrates a simplest embodiment. This application uses cattle to heat a small size garage. The vapor latent heat is not used in this implementation.

It is good choice for hobby farmer to use individual cow-like size animal as a 1 kw heater. Just tie the animal in vicinity of garage even with only open air camp, hook the water jacket and indoor water carpet, and then it is OK.

FIG. 3 illustrates a herd-based combined heat and power plant.

All animals wear water jackets (1). There are two water hoses and one vapor hose every jacket. All hoses are hooked to ground pipe-matrix (2). Therein 2 main pipes are for water, 1 main pipe for vapor. Water main pipes are connected with barn-side water tank (5) in which water level should be at least above all animals standing height to ensure that all water jackets can be fully filled with water. Vapor main pipe is connected with vapor compressor (3) that compresses vapor to induce high pressure and temperature. The compressed vapor is very close to saturate status, and discharged to condenser (10) that is submerged in water tank (5), therein the vapor latent heat is absorbed. For better circulation between water jackets and tank, electric pumps (9) may be required.

Nearby house, there are 2 tanks (6) and (7): the tank (6) is simply hooked to barn-side tank (5) by a long insulated pipe; the tank (7) just for hot water storage.

The heat pump (4) is used to draw heat from tank (6) and heat tank (7). The house is equipped with RFHS. The inlet and outlet are normally hooked to tank (7) via conjugated 3-way valves (12) that may unhook tank (7) and switch to hook tank (6) for air-conditioning purpose in summer.

The heat engine (8) works on hot water tank (7), and a switchable cold heat reservoir of 2 choices: lagoon condenser (10) that is good for summer and open air ambient that is good for winter. The valve (11) is just for thereof switch purpose. The heat engine can drive a generator for electric power production.

The hot water tank (7) can simultaneously heat a resident house and a vegetable greenhouse with RFHS.

Free-stall barn is not fit to the invention. Tie-stall or pen-stall barn is suitable. For prevention from hose kinking, every single stall can not be too large size. The good stall should not let animal turn around no easy.

I claim:

1. A wearable device of water jacket for large size animal, such as bovine and equine, comprising insulation outer layer, core flat water-bag layer that is made of flexible elastic material such as rubber, and liner layer, water inlet and outlet, zipper and/or buttons and/or strings, and/or vapor collection manifold.

2. A Radiant Floor Heating System (RFHS) that directly or indirectly exchanges heat between the large size livestock body heat and indoor space air heat.

3. In addition to claim 2, there are two methods to extract heat from livestock: one is by water circulation between livestock jackets and water tank; the other is by intaking body vapor and compressing to high temperature, then condensing in water tank.

4. A Combined Heat and Power (CHP) system that supports intergrowth or paragenesis to large livestock operation and large scale heat consuming business, such as diary and vegetable greenhouse business, as well as provides output in form of electricity or mechanic work.

5. The CHP system of claim 4, wherein the heat in barn-side warm water tank is transferred to house-side hot water tank via heat pump.

6. The CHP system of claim 4, wherein the heat in house-side hot water tank is fed to radiant floor heating system, and distributed to nearby helio-greenhouse.

7. The CHP system of claim 4, wherein a heat engine intakes the heat in house-side hot water tank, and outputs mechanic work, as well as rejects unwanted heat to ambient air or lagoon bed heat exchanger depending on which one is more cold.

8. The CHP system of claim 4, wherein the inlet and outlet ports of radiant floor heating system can be switched between hot water tank and warm water tank depending on the season. In summer, barn-side warm water tank can be hooked to radiant floor heating system for cooling purpose. In winter, the RFHS playing heating function, it is better to switch to house-side hot water tank.
